(19) United States
(12) Patent Application Publication
(10) Pub. No.: US 2026/0239193 A1
(43) Pub. Date: Aug. 13, 2026

(54) CONFIGURATIONS FOR SUPPORTING NETWORK ENERGY SAVINGS (NES) MODES FOR CELLULAR MOBILITY

(71) Applicant: Telefonaktiebolaget LM Ericsson (publ), Stockholm (SE)

(72) Inventors: Lian ARAUJO, Solna (SE); Nianshan SHI, Järfälla (SE); Mattias BERGSTRÖM, Sollentuna (SE)

(21) Appl. No.: 19/471,292

(22) PCT Filed: Apr. 5, 2024
(86) PCT No.: PCT/SE2024/050317

§ 371 Date: Sep. 30, 2025

Related U.S. Application Data
(60) Provisional application No. 63/494,273, filed on Apr. 5, 2023.

(51) Int. Cl. H04W 52/02; H04W 28/02; H04W 36/08; H04W 36/16

(52) U.S. Cl. CPC H04W 52/0206; H04W 28/0268; H04W 36/08; H04W 36/165

(57) ABSTRACT

A first network node is provided. The first network node is configured to receive a first indication indicating the second network node is operating in a first operating mode, where the first operating mode is a non-network energy savings, NES, mode or one of a plurality of NES modes, determine whether the second network node should transition to a second operating mode different from the first operating mode, where the second operating mode is the non-NES mode or one of the plurality of NES modes, and transmit a request for the second network node to transition to the second operating mode, where the request is based on the determination to transition the second network node.

### TECHNICAL FIELD

The present disclosure relates to wireless communications, and in particular, to configurations for supporting network energy savings (NES) modes and cellular mobility.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

Energy consumption is a considerable challenge of 5G systems today, where a major contributor to the energy consumption is the radio unit of the RAN system. The network (NW) power consumption of NR systems may in many cases be less than the consumption of LTE systems because of NR's leaner design, e.g., no CRS, the SSB periodicity is by default 20 ms, etc. However, some existing systems NR may consume more energy compared to LTE under some conditions, e.g., due to higher bandwidths (BWs), shorter transmission time intervals (TTIs), massive numbers of antennas, etc. Further, energy consumption in some 5G systems may occur even at times when cells and beams are lightly loaded, or even when they serve no traffic or no users at all. To enable an energy efficient NW, 3GPP has initiated a study item (SI) on network energy savings (NES) in NR, as described, for example, in Technical Report (TR) 38.864.

In TR 38.864, a network energy saving technique was studied that enables the WD (e.g., UE) to send an uplink wake-up signal (WUS) to request transitioning of a cell from no transmission/reception activity, or reduced transmission/reception activity, to active transmission or reception of a channel and/or signal. The technique may be applied to WDs in one or more radio resource control (RRC) states. The WD WUS may be used to trigger the SSB/SIB transmission (e.g., by a network node such as a base station/gNB), to trigger SSB/SIB1 transmissions, and/or to trigger a network node (e.g., gNB) to wake up.

With the support of WUS, the network node (e.g., gNB) may be inactive (e.g., where it does not transmit or receive a signal and/or channel, or where it only transmits and receives limited signals). A network node (e.g., gNB) may transition to becoming active for transmitting or receiving a channel/signal upon reception of an uplink signal from the WD.

However, in some existing systems, if a cell (i.e., network node(s)/base station(s) in a cell) is applying an energy saving technique (e.g., transmitting sparser SSBs), there may be no coordination between this cell and other cells (e.g., a cluster of cells may be sleeping, and the entire cluster area may be without coverage towards the WD). Similarly, the NW may not be able to handover WDs to other cells (i.e., other network nodes/base stations) applying an energy saving technique, because the applied energy saving technique may prevent WDs from being connected to that cell. Further, in some NES scenarios, a handover procedure may suffer from additional undesired latency.

Thus, existing systems lack configurations for supporting network energy savings and cellular mobility.

### SUMMARY

Some embodiments advantageously provide methods, systems, and apparatuses for supporting network energy savings (NES) modes and cellular mobility.

For example, some embodiments provide techniques for communication between network nodes related to applied energy saving techniques, and signaling instructions to apply or not apply various energy saving techniques/configurations.

For example, some embodiments provide support for a method at a cell and/or network node related to applied energy saving techniques, and instructions/configurations for applying or not applying various energy saving techniques/configuration. The method may include a first network node of a first cell in communication with a second network node of a second cell, where the second network node (and/or second cell) is operating in an NES mode for energy savings, and where the first network node signals to the second network node an instruction or request that the second network node/second cell transition to a “normal” mode of operation (i.e., to stop use of the NES mode). The method may include the first network node indicating/instructing/requesting to the second network node that the second network node use a different NES mode than the currently configured NES mode. The method may include the first network node indicating to the second network node information related to the NES mode currently used by the first network node/first cell. The method may include, during a handover procedure from a source network node/cell to a target network node/cell, the target network node indicating to the source network node that the target network node may only “wake up” for providing a limited set of services to one or more WDs.

Some embodiments may provide support for a method at a WD (e.g., UE), such as for performing a handover between a first (e.g., source) network node/first cell and a second (e.g., target) network node/second cell. The method may include the WD indicating to the first network node whether the second network node/second cell that the WD has detected and/or measured is in a NES state, enabling the first network node to utilize that information when determining whether to perform a handover of the WD from the first network node/first cell to the second network node/second cell.

Embodiments of the present disclosure may enable the network (e.g., network nodes of one or more cells) to coordinate energy saving techniques applied in each cell and/or network node, which may provide improved coverage and quality of service for WDs while also allowing the NW to sleep efficiently when possible, thereby saving power consumption, as compared to existing systems.

According to one aspect of the present disclosure, a method performed by a wireless device that is configured to communicate with a first network node in a first cell is provided. Signaling from a second network node is measured. The second network node is determined to be operating in a first network energy savings, NES, mode based on the measured signaling. A first indication is transmitted to the first network node of the first NES mode of the second network node. Communication with the second network node is performed based on the second network node having transitioned to a second operating mode different from the first NES mode.

According to one or more embodiments of this aspect, responsive to the first indication, a handover message is received from the first network node causing the wireless device to participate in a handover procedure.

According to one or more embodiments of this aspect, the first indication indicates that the wireless device is in an emergency state, the handover message causing the wireless device to perform a handover to the second network node based on the wireless device being in the emergency state.

According to one or more embodiments of this aspect, the first indication is received in a measurement report.

According to one or more embodiments of this aspect, the first network node is a master node and the second network node is a secondary node, and the transition of the second network node to the second operating mode is configured to provide a secondary cell group, SCG, configuration for the wireless device.

According to another aspect of the present disclosure, a wireless device is configured to communicate with a first network node in a first cell is provided. The wireless device is configured to: measure signaling from a second network node, determine the second network node is operating in a first network energy savings, NES, mode based on the measured signaling, transmit a first indication to the first network node of the first NES mode of the second network node, and communicate with the second network node based on the second network node having transitioned to a second operating mode different from the first NES mode.

According to one or more embodiments of this aspect, the wireless device is further configured to receive, responsive to the first indication, a handover message from the first network node causing the wireless device to participate in a handover procedure.

According to one or more embodiments of this aspect, the first indication indicates that the wireless device is in an emergency state, the handover message causing the wireless device to perform a handover to the second network node based on the wireless device being in the emergency state.

According to one or more embodiments of this aspect, the first indication is received in a measurement report.

According to one or more embodiments of this aspect, the first network node is a master node and the second network node is a secondary node, and the transition of the second network node to the second operating mode being configured to provide a secondary cell group, SCG, configuration for the wireless device.

According to another aspect of the present disclosure, a method implemented by a first network node that is configured to communicate with a wireless device and a second network node is provided. A first indication indicating the second network node is operating in a first operating mode is received where the first operating mode is a non-network energy savings, NES, mode or one of a plurality of NES modes. A determination is made whether the second network node should transition to a second operating mode different from the first operating mode, where the second operating mode is the non-NES mode or one of the plurality of NES modes. A request for the second network node to transition to the second operating mode is transmitted where the request is based on the determination to transition the second network node.

According to one or more embodiments of this aspect, the second operation mode is a NES-mode, and the request is configured to request for the second network node to transition from the NES-mode to a non-NES mode.

According to one or more embodiments of this aspect, the first indication is received by the wireless device.

According to one or more embodiments of this aspect, a determination is made to handover the wireless device to the second network node, where the determination to transition the second network node to the second operating mode is based on the handover determination.

According to one or more embodiments of this aspect, the first indication is received in a measurement report.

According to one or more embodiments of this aspect, the first indication is received from the second network node, the second network node is a target node for handover.

According to one or more embodiments of this aspect, information indicating that the second network node is configured to enter the non-NES mode to support at least one predefined service is received from the second network node.

According to one or more embodiments of this aspect, the at least one predefined service comprises one of an emergency service or a service having a predefined 5G quality of service Identifier, 5QI, value.

According to one or more embodiments of this aspect, the first network node is a master node and the second network node is a secondary node, and the transition of the second network node to the second operating mode is configured to provide a secondary cell group, SCG, configuration for the wireless device.

According to one or more embodiments of this aspect, the determination that the second network node should transition to the second operating mode is based on at least one of a speed of the wireless device or a position of the wireless device.

According to one or more embodiments of this aspect, a plurality of indications from a plurality of network nodes are received, where each indication indicates whether a respective network node of the plurality of network nodes is operating in the first operating mode, and a determination is made to handover a wireless device to one of the plurality of network nodes that is operating in the non-NES mode.

According to another aspect of the present disclosure, a first network node configured to communicate with a wireless device and a second network node is provided. The first network node configured to receive a first indication indicating the second network node is operating in a first operating mode, where the first operating mode is a non-network energy savings, NES, mode or one of a plurality of NES modes, determine whether the second network node should transition to a second operating mode different from the first operating mode where the second operating mode is the non-NES mode or one of the plurality of NES modes, and transmit a request for the second network node to transition to the second operating mode where the request is based on the determination to transition the second network node.

According to one or more embodiments of this aspect, the second operation mode is a NES-mode, and the request is configured to request for the second network node to transition from the NES-mode to a non-NES mode.

According to one or more embodiments of this aspect, the first indication is received by the wireless device.

According to one or more embodiments of this aspect, the first network node is configured to determine to handover the wireless device to the second network node where the determination to transition the second network node to the second operating mode is based on the handover determination.

According to one or more embodiments of this aspect, the first indication is received in a measurement report.

According to one or more embodiments of this aspect, the first indication is received from the second network node where the second network node is a target node for handover.

According to one or more embodiments of this aspect, the first network node is further configured to receive, from the second network node, information indicating that the second network node is configured to enter the non-NES mode to support at least one predefined service.

According to one or more embodiments of this aspect, the at least one predefined service comprises one of an emergency service or a service having a predefined 5G quality of service Identifier, 5QI, value.

According to one or more embodiments of this aspect, the first network node is a master node and the second network node is a secondary node, and the transition of the second network node to the second operating mode is configured to provide a secondary cell group, SCG, configuration for the wireless device.

According to one or more embodiments of this aspect, the determination that the second network node should transition to the second operating mode is based on at least one of a speed of the wireless device or a position of the wireless device.

According to one or more embodiments of this aspect, the first network node is configured to: receive a plurality of indications from a plurality of network nodes, where each indication indicates whether a respective network node of the plurality of network nodes is operating in the first operating mode, and determine to handover a wireless device to one of the plurality of network nodes that is operating in the non-NES mode.

According to another aspect of the present disclosure, a method implemented by a first network node in a first cell is provided. The first network node is configured to communicate with a wireless device and a second network node in a second cell. A first indication is transmitted to the second network node where the first indication indicates the first network node is operating in a first operating mode where the first operating mode is a non-network energy savings, NES, mode or one of a plurality of NES modes. A request is received from the second network node that requests for the first network node to transition to a second operating mode different from the first operating mode. In response to the request, a determination is made whether to transition to the second operating mode. The second operating mode is transitions based on the determination.

According to one or more embodiments of this aspect, the first operation mode is a NES-mode, and the request is configured to request for the first network node to transition from the NES-mode to a non-NES mode.

According to one or more embodiments of this aspect, the first network node is a target network node for handover of the wireless device.

According to one or more embodiments of this aspect, information indicating that the first network node is configured to enter the non-NES mode to support at least one predefined service is transmitted to the second network node.

According to one or more embodiments of this aspect, the at least one predefined service comprises one of an emergency service or a service having a predefined 5G quality of service Identifier, 5QI, value.

According to one or more embodiments of this aspect, the first network node is a secondary node and the second network node is a master node, and the transition of the first network node to the second operating mode being configured to provide a secondary cell group, SCG, configuration for the wireless device.

According to one or more embodiments of this aspect, the determination to transition to the second operating mode being based on at least one of: a traffic load of the first network node, a quality of service requirement of the wireless device, a service type requested by and/or associated with the wireless device, an emergency state of the wireless device, a location of the wireless device, or a velocity of the wireless device.

According to another aspect of the present disclosure, a first network node in a first cell is configured to communicate with a wireless device and a second network node in a second cell. The first network node is configured to transmit a first indication to the second network node where the first indication indicates the first network node is operating in a first operating mode, and where the first operating mode is a non-network energy savings, NES, mode or one of a plurality of NES modes, receive a request from the second network node that requests for the first network node to transition to a second operating mode different from the first operating mode, in response to the request, determine whether to transition to the second operating mode, and transition to the second operating mode based on the determination.

According to one or more embodiments of this aspect, the first operation mode is a NES-mode, and the request is configured to request for the first network node to transition from the NES-mode to a non-NES mode.

According to one or more embodiments of this aspect, the first network node is a target network node for handover of the wireless device.

According to one or more embodiments of this aspect, the first network node is further configured to transmit, to the second network node, information indicating that the first network node is configured to enter the non-NES mode to support at least one predefined service.

According to one or more embodiments of this aspect, the at least one predefined service comprises one of an emergency service or a service having a predefined 5G quality of service Identifier, 5QI, value.

According to one or more embodiments of this aspect, the first network node is a secondary node and the second network node is a master node, and the transition of the first network node to the second operating mode being configured to provide a secondary cell group, SCG, configuration for the wireless device.

According to one or more embodiments of this aspect, the determination to transition to the second operating mode being based on at least one of a traffic load of the first network node, a quality of service requirement of the wireless device, a service type requested by and/or associated with the wireless device, an emergency state of the wireless device, a location of the wireless device, or a velocity of the wireless device.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node (e.g., a serving network node) for supporting NES modes and cellular mobility, according to some embodiments of the present disclosure;

FIG. 8 is a flowchart of another example process in a network node (e.g., a serving network node) for supporting NES modes and cellular mobility, according to some embodiments of the present disclosure;

FIG. 9 is a flowchart of an example process in a network node (e.g., a target network node) for supporting NES modes and cellular mobility, according to some embodiments of the present disclosure; and

FIG. 10 is a flowchart of another example process in a network node (e.g., a target network node) for supporting NES modes and cellular mobility, according to some embodiments of the present disclosure;

FIG. 11 is a flowchart of an example process in a wireless device for supporting NES modes and cellular mobility, according to some embodiments of the present disclosure; and

FIG. 12 is a flowchart of another example process in a wireless device for supporting NES modes and cellular mobility, according to some embodiments of the present disclosure.

### DETAILED DESCRIPTION

Before describing in detail example embodiments, it is noted that the embodiments reside primarily in combinations of apparatus components and processing steps related to supporting NES modes and cellular mobility. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide configurations, techniques, and methods for supporting NES modes and cellular mobility.

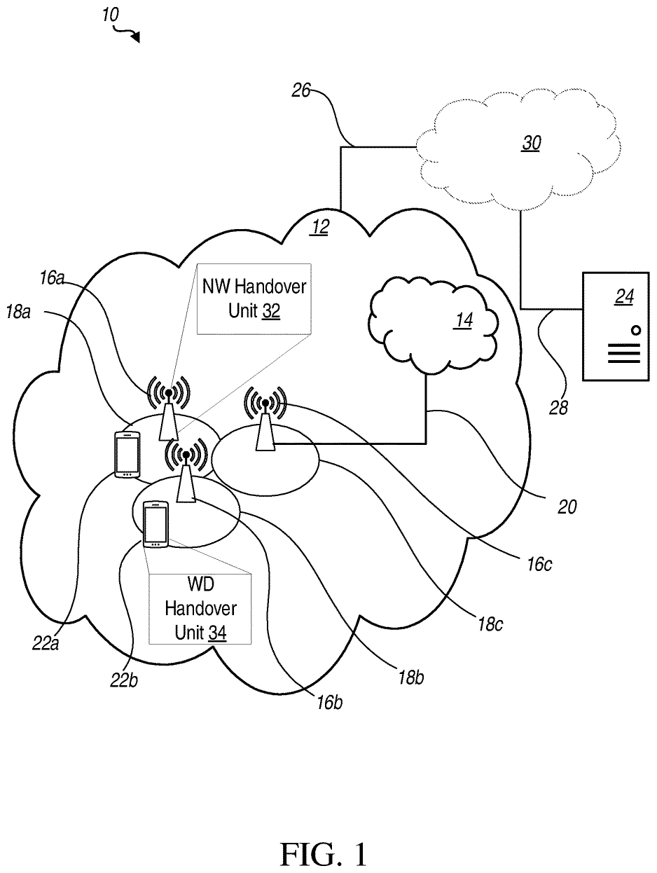

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding cells (also known as “coverage area”) 18a, 18b, 18c (referred to collectively as cells 18). Each network node 16a, 16b, 16c is connectable to the core network 14 over a wired or wireless connection 20. A first wireless device (WD) 22a located in cell 18a is configured to wirelessly connect to, or be paged by, the corresponding network node 16a. A second WD 22b in cell 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the cell or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a network (NW) handover unit 32 which is configured for supporting NES modes and cellular mobility. A wireless device 22 is configured to include a WD handover unit 34 which is configured for supporting NES modes and cellular mobility.

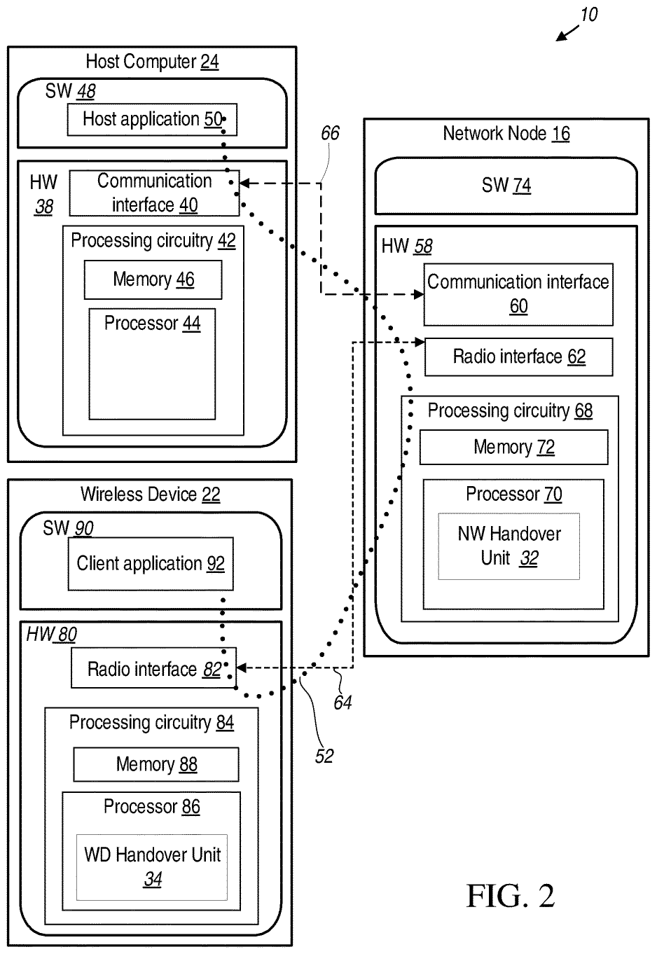

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a cell 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include NW handover unit 32 configured for supporting NES modes and cellular mobility.

The communication system 10 further includes the WD 22 already referred to. The WD 22 may have hardware 80 that may include a radio interface 82 configured to set up and maintain a wireless connection 64 with a network node 16 serving a cell 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a WD handover unit 34 configured for supporting NES modes and cellular mobility.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as NW handover unit 32, and WD handover unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

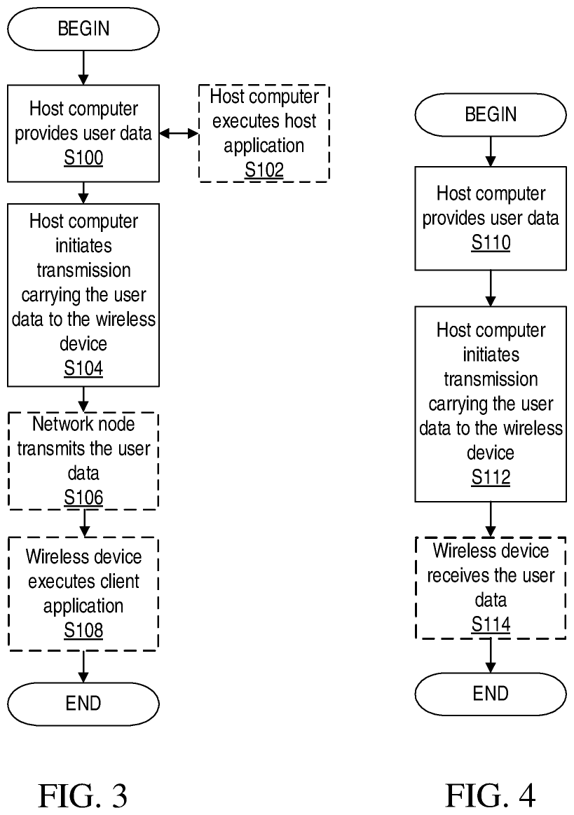

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

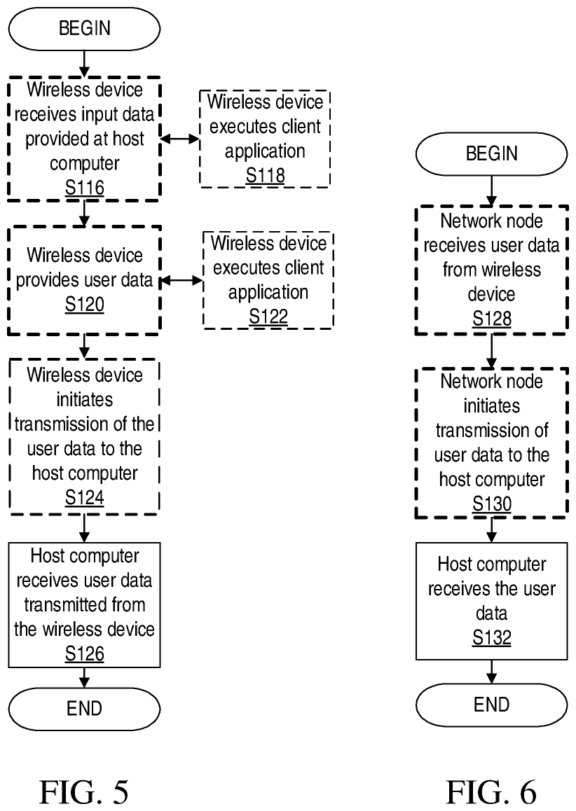

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

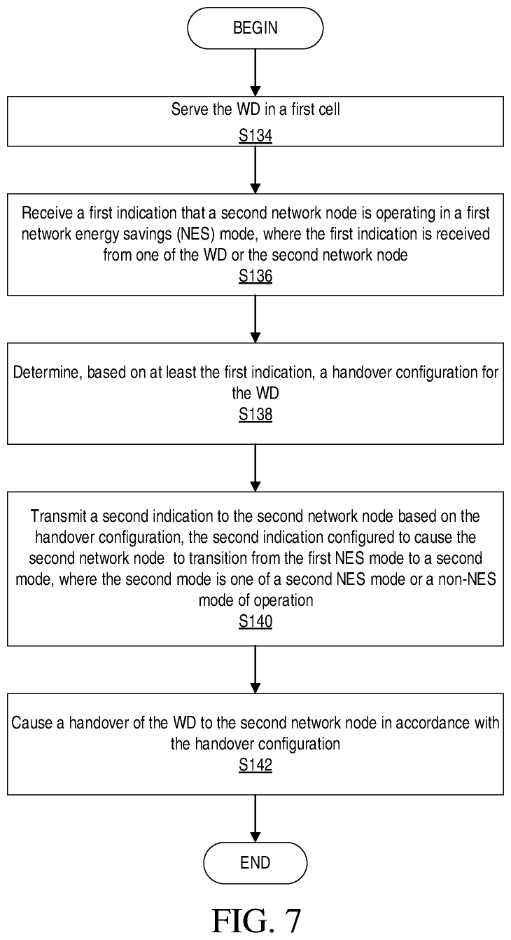

FIG. 7 is a flowchart of an example process in a first network node 16 (e.g., a source network node 16) for supporting NES modes and cellular mobility. One or more blocks described herein may be performed by one or more elements of network node 16 such as by one or more of processing circuitry 68 (including the NW handover unit 32), processor 70, radio interface 62 and/or communication interface 60. The first network node 16 is configured to serve (Block S134) the WD 22 in a first cell 18. The first network node 16 is configured to receive (Block S136) a first indication that a second network node 16 (e.g., in a second cell 18) is operating in a first network energy savings (NES) mode, where the first indication is received from one of the WD 22 or the second network node 16. The first network node 16 is configured to determine (Block S138), based on at least the first indication, a handover configuration for the WD 22. The first network node 16 is configured to transmit (Block S140) a second indication (e.g., a wake up signal or other control signaling) to the second network node 16 based on the handover configuration, the second indication configured to cause the second network node 16 to transition from the first NES mode to a second mode, where the second mode is one of a second NES mode (e.g., a second NES mode which is different from the first NES mode, such as a mode using more or less power, a mode associated with being in a “deeper” sleep or a less deep sleep, such as being configured for more or less frequent signaling or higher or lower power signaling, a partially awakened mode in which some but not all services/capabilities/etc. are enabled, etc.) or a non-NES mode of operation (e.g., causing the second network node 16 to wake up and enter “normal” operation). The first network node 16 is configured to cause a handover (Block S142) of the WD 22 to the second network node 16 in accordance with the handover configuration (e.g., signaling to the WD 22 information enabling the WD 22 to connect with the second network node 16).

In some embodiments, the second indication corresponds to a handover request. In some embodiments, the first network node 16 is further configured to predict, based on location information (geographic coordinates, velocity, direction, etc.) associated with the WD 22, an upcoming handover opportunity (e.g., predict movement of the WD 22 from the first cell 18 to the second cell 18), and transmit the second indication to the second network node 16 based on the predicted upcoming handover opportunity.

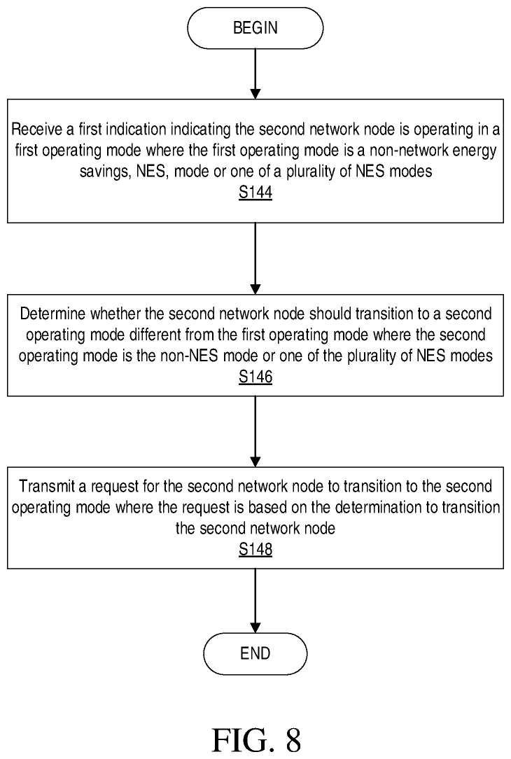

FIG. 8 is a flowchart of another example process in a first network node 16 (e.g., a source network node 16) for supporting NES modes and cellular mobility. One or more blocks described herein may be performed by one or more elements of network node 16 such as by one or more of processing circuitry 68 (including the NW handover unit 32), processor 70, radio interface 62 and/or communication interface 60. The first network node 16 is configured to receive (Block S144) a first indication indicating the second network node 16 is operating in a first operating mode, where the first operating mode is a non-network energy savings, NES, mode or one of a plurality of NES modes, as described herein. The first network node 16 is configured to determine (Block S146) whether the second network node 16 should transition to a second operating mode different from the first operating mode, where the second operating mode is the non-NES mode or one of the plurality of NES modes, as described herein. The first network node 16 is configured to transmit (Block S148) a request for the second network node 16 to transition to the second operating mode, where the request is based on the determination to transition the second network node 16, as described herein.

According to one or more embodiments, the second operation mode is a NES-mode, and the request is configured to request for the second network node 16 to transition from the NES-mode to a non-NES mode.

According to one or more embodiments, the first indication is received by the wireless device 22.

According to one or more embodiments, the first network node 16 is configured to determine to handover the wireless device 22 to the second network node 16, where the determination to transition the second network node 16 to the second operating mode is based on the handover determination.

According to one or more embodiments, the first indication is received in a measurement report.

According to one or more embodiments, the first indication is received from the second network node 16, the second network node 16 is a target node for handover.

According to one or more embodiments, the first network node 16 is further configured to receive, from the second network node 16, information indicating that the second network node 16 is configured to enter the non-NES mode to support at least one predefined service.

According to one or more embodiments, the at least one predefined service comprises one of an emergency service or a service having a predefined 5G quality of service Identifier, 5QI, value.

According to one or more embodiments, the first network node 16 is a master node and the second network node 16 is a secondary node, and the transition of the second network node 16 to the second operating mode being configured to provide a secondary cell group, SCG, configuration for the wireless device 22.

According to one or more embodiments, the determination that the second network node 16 should transition to the second operating mode is based on at least one of a speed of the wireless device 22 or a position of the wireless device 22.

According to one or more embodiments, the first network node 16 is configured to: receive a plurality of indications from a plurality of network nodes 16, where each indication indicates whether a respective network node 16 of the plurality of network nodes 16 is operating in the first operating mode, and determine to handover a wireless device 22 to one of the plurality of network nodes 16 that is operating in the non-NES mode.

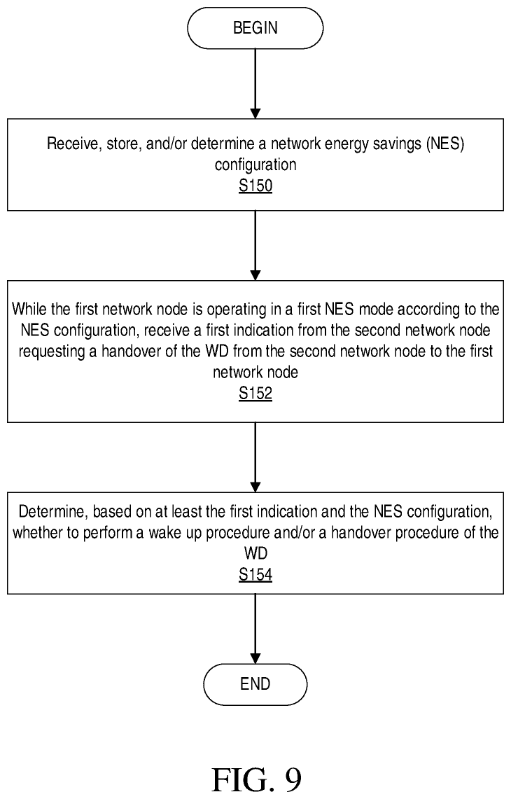

FIG. 9 is a flowchart of an example process in a first network node 16 (e.g., a target network node 16) for supporting NES modes and cellular mobility. One or more blocks described herein may be performed by one or more elements of network node 16 such as by one or more of processing circuitry 68 (including the NW handover unit 32), processor 70, radio interface 62 and/or communication interface 60. The first network node 16 is configured to receive, store, and/or determine (Block S150) a network energy savings (NES) configuration. While the first network node 16 is operating in a first NES mode according to the NES configuration, the first network node 16 is configured to receive (Block S152) a first indication from the second network node 16 (e.g., a serving network node 16 which is currently serving WD 22) requesting a handover of the WD 22 from the second network node 16 to the first network node 16 (and/or signaling a wake up signal for the first network node 16). Network node 16 is configured to determine (Block S154), based on at least the first indication and the NES configuration, whether to perform a wake up procedure (e.g., of the first network node 16, such as transitioning to a normal state or a second NES mode which is in a less “deep” sleep as compared to the first NES mode) and/or a handover procedure of the WD 22.

In some embodiments, the determining of whether to perform the wake up procedure and/or the handover procedure is further based on at least one of a traffic load of the first network node 16, a quality of service requirement of the WD 22, a service type requested by and/or associated with the WD 22, an emergency state of the WD 22 (e.g., if the WD 22 needs to make an emergency call or is currently on an emergency call), a location of the WD 22, and/or a velocity of the WD 22. In some embodiments, the wake up procedure includes, based on the first indication and/or the NES configuration, transitioning from the first NES mode to a second NES mode, where the first NES mode does not enable service of the WD 22 in the first cell 18 and the second NES enables service of the WD 22 in the first cell 18, or transitioning from the first NES mode to a normal (i.e., non-NES) mode, where the normal mode enables service of the WD 22 in the first cell 18.

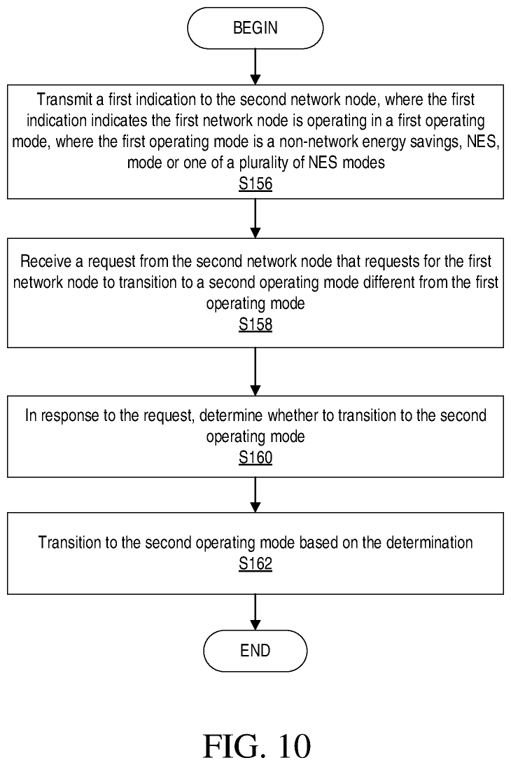

FIG. 10 is a flowchart of another example process in a first network node 16 (e.g., a target network node 16) for supporting NES modes and cellular mobility. One or more blocks described herein may be performed by one or more elements of network node 16 such as by one or more of processing circuitry 68 (including the NW handover unit 32), processor 70, radio interface 62 and/or communication interface 60. The first network node 16 is configured to transmit (Block S156) a first indication to the second network node 16 where the first indication indicates the first network node 16 is operating in a first operating mode, where the first operating mode is a non-network energy savings, NES, mode or one of a plurality of NES modes, as described herein. The first network node 16 is configured to receive (Block S158) a request from the second network node 16 that requests for the first network node 16 to transition to a second operating mode different from the first operating mode, as described herein. The first network node 16 is configured to, in response to the request, determine (Block S160) whether to transition to the second operating mode, as described herein. The first network node 16 is configured to transition (Block S162) to the second operating mode based on the determination, as described herein.

According to one or more embodiments, the first operation mode is a NES-mode, and the request is configured to request for the first network node 16 to transition from the NES-mode to a non-NES mode.

According to one or more embodiments, the first network node 16 is a target network node 16 for handover of the wireless device 22.

According to one or more embodiments, the first network node 16 is further configured to transmit, to the second network node 16, information indicating that the first network node 16 is configured to enter the non-NES mode to support at least one predefined service.

According to one or more embodiments, the at least one predefined service comprises one of an emergency service or a service having a predefined 5G quality of service Identifier, 5QI, value.

According to one or more embodiments, the first network node 16 is a secondary node and the second network node 16 is a master node, and the transition of the first network node 16 to the second operating mode being configured to provide a secondary cell group, SCG, configuration for the wireless device 22.

According to one or more embodiments, the determination to transition to the second operating mode being based on at least one of: a traffic load of the first network node 16, a quality of service requirement of the wireless device 22, a service type requested by and/or associated with the wireless device 22, an emergency state of the wireless device 22, a location of the wireless device 22, or a velocity of the wireless device 22.

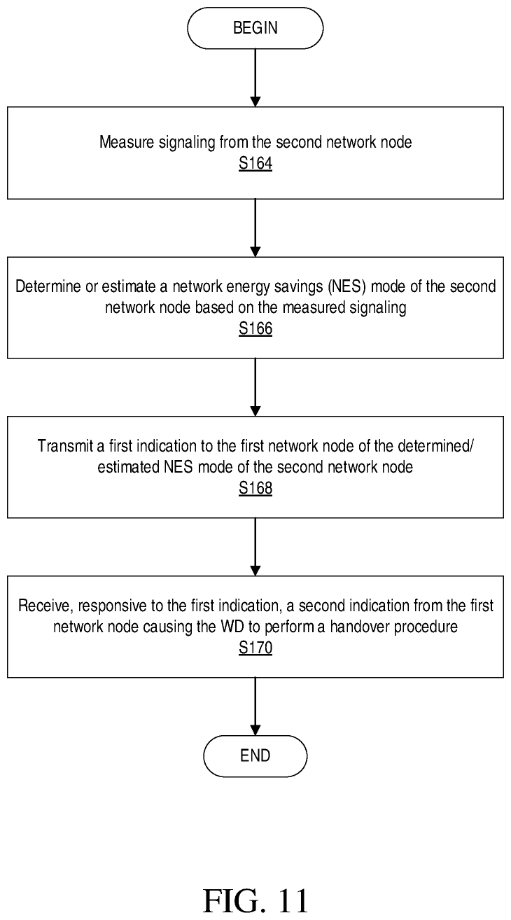

FIG. 11 is a flowchart of an example process in a wireless device 22 according to some embodiments of the present disclosure for supporting NES modes and cellular mobility. One or more blocks described herein may be performed by one or more elements of wireless device 22 such as by one or more of processing circuitry 84 (including the WD handover unit 34), processor 86, radio interface 82 and/or communication interface 60. The wireless device 22 is configured to communicate with a first network node 16 in a first cell 18 (e.g., a serving network node 16) and a second network node 16 in a second cell 18 (e.g., a target network node 16). Wireless device 22 is configured to measure (Block S164) signaling from the second network node 16. Wireless device 22 is configured to determine or estimate (Block S166) a network energy savings (NES) mode of the second network node 16 based on the measured signaling (e.g., if reference signaling emitted by the second network node 16 maps to a signaling configuration expected for a corresponding NES mode, as determinable by the WD 22 according to received or preconfigured NES configuration information). Wireless device 22 is configured to transmit (Block S168) a first indication to the first network node 16 of the determined/estimated NES mode of the second network node 16. The wireless device 22 is configured to receive (Block S170), responsive to the first indication, a second indication from the first network node 16 causing the WD to perform a handover procedure (e.g., from the first (source) network node 16 to the second (target) network node 16, or to another (target) network node 16, such as a third (target) network node 16).

In some embodiments, the WD 22 is further configured to measure signaling from a third network node 16 in a third cell 18, and determine the third network node 16 to be operating in a normal (i.e., non-NES) mode, where the first indication to the first network node 16 indicates that the third network node 16 is in the normal mode. The WD 22 is further configured to perform the handover from the first network node 16 according to either (a) the second network node 16 based on a first quality of the measured signaling from the second network node 16 being greater than a second quality of the measured signaling from the third network node 16 (and/or the difference in quality is greater than a preconfigured threshold), or (b) to the third network node 16 based on the second network node 16 being in the NES mode (e.g., the first network node 16 determines not to wake up the second network node 16 based on configuration information, a state of the network, power savings configurations, location information of the network nodes 16, traffic loads, etc.). In some embodiments, the first indication indicates that the WD 22 is in an emergency state, the second indication causing the WD 22 to perform a handover to the second network node 16 based on the WD 22 being in the emergency state (e.g., the second network node 16 may be configured to only wake up and receive a handover of a WD 22 from the first network node 16 if it receives an indication that the WD 22 is in an emergency state, and/or the first network node 16 may be configured with information indicating the second network node 16 is configured to only wake up for emergency traffic, and the first network node 16 does not wake up the second network node 16, accordingly). Thus, in some embodiments, signaling from the WD 22 to a (serving) network node 16 may cause the network node 16 to send wake up signaling to one or more other network nodes 16, such as any one or more of network nodes 16 of neighboring cells 18, network nodes 16 currently operating in an NES mode, network nodes 16 which are targets (or candidate targets) for handover procedures, etc.

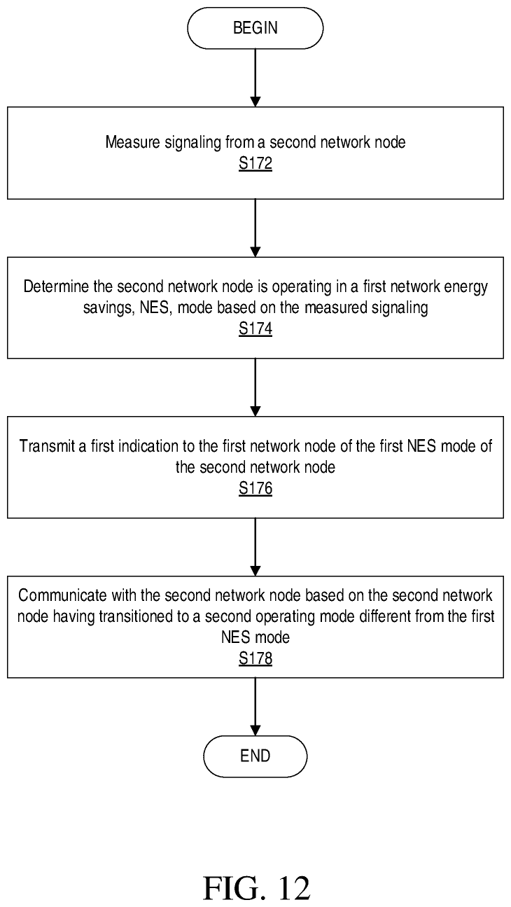

FIG. 12 is a flowchart of another example process in a wireless device 22 according to some embodiments of the present disclosure for supporting NES modes and cellular mobility. One or more blocks described herein may be performed by one or more elements of wireless device 22 such as by one or more of processing circuitry 84 (including the WD handover unit 34), processor 86, radio interface 82 and/or communication interface 60. The wireless device 22 is configured to measure (Block S172) signaling from a second network node 16, as described herein. The wireless device 22 is configured to determine (Block S174) the second network node 16 is operating in a first network energy savings, NES, mode based on the measured signaling, as described herein. The wireless device 22 is configured to transmit (Block S176 a first indication to the first network node 16 of the first NES mode of the second network node 16, as described herein. The wireless device 22 is configured to communicate (Block S178) with the second network node 16 based on the second network node 16 having transitioned to a second operating mode different from the first NES mode, as described herein.

According to one or more embodiments, the wireless device 22 is further configured to receive, responsive to the first indication, a handover message from the first network node 16 causing the wireless device 22 to participate in a handover procedure.

According to one or more embodiments, the first indication indicates that the wireless device 22 is in an emergency state, the handover message causing the wireless device 22 to perform a handover to the second network node 16 based on the wireless device 22 being in the emergency state.

According to one or more embodiments, the first indication is received in a measurement report.

According to one or more embodiments, the first network node 16 is a master node 16 and the second network node 16 is a secondary node, and the transition of the second network node 16 to the second operating mode being configured to provide a secondary cell group, SCG, configuration for the wireless device 22.

Having described the general process flow of arrangements of the disclosure and having provided examples of hardware and software arrangements for implementing the processes and functions of the disclosure, the sections below provide details and examples of arrangements for supporting NES modes and cellular mobility.

As used herein, “NES mode” may refer to a network node/cell transmitting sparser SSBs or CSI-RS, or no SSBs or CSI-RS (e.g., as compared to a “normal” mode of operation), may refer to less transmission on UL and/or DL (e.g., as compared to a “normal” mode of operation), and/or may refer to any of the sleeping modes described herein (e.g., one or more sleeping modes as defined in TR 38.864).

### NG-RAN Network Side Solutions

Some embodiments may provide configurations and methods at a network node 16 (e.g., base station) for supporting NES modes and WD 22 mobility.

Embodiments enable network nodes 16 to coordinate on the use of NES mode(s). For example, some embodiments may include a first network node 16 performing one or more of the following non-limiting example procedures:

Example AA1. Indicating/requesting/instructing to another network node 16 or another cell 18 that the other network node 16 or cell 18 should operate be in normal mode of operation (i.e., to stop use of a configured NES mode, or to maintain the normal mode of operation if the normal mode is currently configured);

Example AA2. Indicating/requesting/instructing to another network node 16 or cell 18 that the other network node 16 or cell 18 should use a different NES mode than what is currently configured;

Example AA3. Indicating/requesting/instructing to another network node 16 or cell 18 that the other network node 16 or cell 18 information regarding the NES mode currently used by the first network node 16 (and/or by a first cell 18 associated with the first network node 16);

Example AA4. The method of Examples AA1 or AA2, where the indication/request/instruction includes NES configuration information such as a priority list of operation modes (e.g., if possible, the second network node 16 should operate in a normal mode of operation, and if that is not possible, the second network node 16 should operate in a micro sleep mode, and if neither mode is possible, the second network node 16 should operate in a light sleep mode, etc.). The priorities of operation modes may be determined based on or related to, e.g., NW load, quality of service for WDs 22, WD 22 measurements, etc.

Example AA5. The method of any of Examples AA1-AA4, where the indication/request/instruction is sent in a dual connectivity case, e.g., upon a network node 16 (e.g., Secondary Node (SN)) addition, a SN change or modification, etc.
a. In some embodiments, the second network node 16 (e.g., SN) may be using an NES mode which enables the WD 22 to detect such network node 16 (SN), but not to be connected to such network node 16 (SN). The first network node 16 (e.g., Master Node (MN)) may be configured to send an indication/request/instruction to this second network node 16 (SN) to operate in a normal mode of operation, to enable the second network node 16 (SN) to provide SCG configuration to this WD 22.
b. In some embodiments, WDs 22 configured with both Master Cell Group Configuration (MCG) and Secondary Cell Group Configuration (SCG) configurations may be configured with only SRB1, e.g., enabling the second network node 16 (SN) to apply further NES mode(s). When the first network node 16 (MN) conditions change (e.g., a load in the first network node 16 (MN) is above a preconfigured threshold), the first network node 16 (MN) may be configured to send an indication/request/instruction for the second network node 16 (SN) to configure SRB3.

Example AA6. The method of any one of Examples AA1-AA5, where the indication/request/instruction is sent in a handover case, e.g., upon handover request or Conditional Handover (CHO), or is otherwise associated with a handover procedure, such as:
a. The second (target) network node 16 may be configured to operate using an NES mode which enables the WD 22 to detect such target network node 16, but where the NES mode does not enable the second (target) network node 16 to be connected to the WD 22. The first (source) network node 16 may be configured to send an indication/request/instruction to the second (target) network node 16 to configure it to operate in a normal mode of operation, enabling the second (target) network node to provide RRC configuration information or other necessary signaling/information to this WD 22. The indication/request/instruction may be implicit, e.g., with the handover request message, or explicit, e.g., as a separate signaling.
b. Alternatively, the second (target) network node 16 may be configured to use an NES mode that does not enable the WD 22 to detect such second (target) network node 16. The first (source) network node 16 may be configured to derive the need for the second (target) network node 16 to be configured to operate in a normal mode of operation based on other means/signaling, e.g., based on WD 22 position, speed, etc., the first (source) network node 16 may determine that the WD 22 is going to be leaving the first cell 18 and will soon be covered by the second cell 18 associated with the second (target) network node 16, and may signal the second (target) network node 16 to exit the NES mode, or to at least change to another NES mode which supports handover and/or connectivity with the WD 22, accordingly.

Example AA7. The method of any one of Example AA1-AA6, where the indication/request/instruction is sent in the context of a CU-DU split, e.g., where a first network node 16 is configured as a CU, and a second (or third, fourth, etc.) network node 16 is configured as a DU, and where the indication/request/instruction is handled by one or more CUs and DUs associated with (or implemented by) one or more first network nodes 16 of a first cell 18 and/or by one or more CUs and DUs associated with (or implemented by) one or more second network nodes 16 of a second cell 18.

Example AA8. The method of any one of Examples AA1-AA7, where the indication/request/instruction is included in (and/or corresponds to) a HandoverPreparationInformation message, a CG-ConfigInfo message, and/or CG-Config message.

Example AA9. The method of any one of Examples AA1-AA8, where the indication/request/instruction is included in XnAP, X2AP, and/or F1AP signaling.

Example AA10. The method of any one of Examples AA1-AA9, where, in the context of Xn or NG handover:
a. Upon the reception from the first (source) network node 16, the second (target) network node 16 may determine, based on its own load and/or the services requested for the incoming WD 22, if it will wake up and perform handover.
b. The first (source) network node 16 may be configured to, in advance, wake up the neighboring potential handover target network node 16, in order to avoid any extra latency related to the target cell needs time to wake up and serve the WD 22.
c. The first (source) network node 16 may provide a time period for the neighboring network nodes 16 to keep awaken. After the timer expires, and no WD 22 is handed over, the neighboring network node(s) 16 may be configured to continue to the energy saving state (e.g., an NES mode).
d. A RAN network node 16 may inform its neighboring network nodes 16 that it will only wake up for certain services, where a given time period may be included. The first (source) network node 16 may store this information and use it when considering the Handover target, e.g., in the NG-RAN node Configuration Update procedure. Referring to Table 1, below, the network node 16 (e.g., gNB) may use this information to determine if the WD 22 should measure these cells 18 (and/or network nodes 16 associated with such cells 18) in order to perform handover, or if to trigger the handover request to these cells 18 (i.e., to network nodes 16 associated with these cells 18), which may depend on the services that are currently served.
e. In some embodiments, such information may be included, e.g., in an the Information Element signaled over a XnAP interface.

In some embodiments, one or more cells 18 (e.g., network nodes 16 associated with cells 18) may be configured to enter into energy saving mode and may only be woken up if they are configured to (and/or requested to and/or instructed to, e.g., by another network node 16, by a cloud node, by a host computer 24, etc.) support certain services, e.g., Emergency Services. The source network node 16 (gNB) may determine the services that a certain WD 22 requires/supports/requests/etc. when determining if it should wake up another cell 18 (i.e., another network node 16 associated with another cell 18). For example, if a candidate target cell 18 (i.e., network node(s) 16 of target cell 18) has indicated that it only wants to be woken up/exit network energy saving (NES) mode to serve a WD 22 with emergency services, the source network node 16 (gNB) may be configured to only initiate a handover procedure for a WD 22 which has emergency services ongoing or which is requesting emergency services. The source network node 16 (gNB) may be configured to determine whether a WD 22 has emergency services ongoing or not, for example, based on the WD 22-indicated establishment cause, or based on other signaling, information, conditions, etc. Other types of services and restrictions may be applied in various configurations, e.g., the target network node 16 may be configured to and/or restricted to only wake up for WDs 22 with a certain quality of service (QoS) level, within a certain network slice, priority index, etc., and may be configured to indicate such restrictions/configurations/preferences to another network node 16, e.g., a source network node 16.

In some embodiments, a first network node 16 indicates to a second network node 16 under which condition the first network node 16 would prefer to be woken up. These conditions may include, for example, that the WD 22s which are about to be handed over are using certain 5QIs, which may be referred to as “allowed 5QIs”. This may be accompanied by an indication of, e.g., for how long (i.e. a duration) such conditions may apply. Below is an example Xn specification implementing these aspects, where “allowed 5QIs to wake up” and “duration” are added to existing signaling structures to implement this embodiment.

TABLE 1
Example embodiment wherein the cell 18/network node 16 will only
wake up when the indicated service is to be served, e.g. during handover.
TS 38.423 Chapter 9.1.3.4 NG-RAN NODE CONFIGURATION UPDATE

| | | | | | | |
|---|---|---|---|---|---|---|
| IE/Group | | | IE type and | Semantics | | Assigned |
| Name | Presence | Range | reference | description | Criticality | Criticality |

| | | | | |
|---|---|---|---|---|
| Message | M | 9.2.3.1 | YES | reject |
| Type | | | | |

Unrelated IEs Skipped

| | | | | | | |
|---|---|---|---|---|---|---|
| Local | O | | Local NG- | | YES | ignore |
| NG-RAN | | | RAN Node | | | |
| Node | | | Identifier | | | |
| Identifier | | | 9.2.2.101 | | | |
| Removal | | | | | | |
| NES Cell | | 0 . . . 1 | | | YES | reject |
| Information | | | | | | |
| >NR Cell | | 1 . . . | | | — | |
| Item | | <maxnoofNRCells> | | | | |
| >>Allowed | O | | ENUMERATED | | — | |
| 5QI to | | | (5Q1 list) | | | |
| wake up | | | | | | |
| >>Duration | O | | Integer | Unit as | — | |
| | | | | second | | |

### Wireless Device 22 Embodiments

In some embodiments, a method is supported in which the WD 22 (e.g., in RRC Connected mode) is configured to indicate to the serving network node 16 (gNB) whether a cell 18 (i.e., of another network node 16) that the WD 22 has measured is in an energy saving state (e.g., an NES mode). The WD 22 may be configured to indicate this to the serving network node 16 (gNB) in a measurement report, for example, by a flag, or with more elaborate/verbose information, e.g., regarding which energy saving features the measured cell 18/network node 16 is using (or is estimated to be using).

Upon reception of such information, a source network node 16 (gNB) may be configured to determine/select a suitable target network node 16/cell 18, based on this information. For example, if the WD 22 sends measurements for one cell 18 which is in normal operation, and another cell 18 which is in network energy saving (NES) mode, the source network node 16 (gNB) may be configured to consider the state (network energy saving state or not) of each potential target network node 16 when selecting which cell 18/which target network node 16 to attempt to handover the WD 22. For example, the source network node 16 (gNB) may prefer to handover a WD 22 to the cell which is already in a normal (i.e., non-NES) mode of operation, e.g., so as to allow the cell 18/network node 16 in network energy saving mode to continue in that mode (e.g., without requiring it to wake up and/or change modes to a higher energy consumption mode). However, the source network node 16 (gNB) may need to consider other information about those cells 18/network nodes 16 too. For example, if the WD 22 reports a first target cell 18/network node 16 which is in network energy saving mode to which the WD 22 has a good quality signal, and a second target cell 18/network node 16 which is in a normal mode, but for which the signal quality is poor, in that case, the source network node 16 (gNB) may determine/select the first target cell 18/network node 16, i.e., by signaling a wake up of the first target cell 18/network node 16 in network energy saving mode, since the signal connection to that cell 18/network node 16 is better than the signal connection to the second cell 18/network node 16, even though the second cell 18/network node 16 does not need to be awakened. In some embodiments, the first network node 16 may only wake up a second network node 16 in an NES state if the second network node 16 signal quality is at least X % better than the signal quality of another network node 16 which is in a non-NES state, where X % is a configured threshold margin.

The following is excerpted from TR 38.864 (clause 5.1):

For power states, for non-sleep mode and TDD, the BS power consumption for DL and UL are separately modelled, allowing DL-only transmission or UL-only reception. The relative power value in power consumption model tables for UL reception and/or DL transmission is provided based on the reference configurations. For simultaneous DL and UL transmission for FDD, the power for UL reception is neglected in this study.

The power states of power consumption model are provided as Table 5.1-2. Note: The BS power model defined in this study is a simplified model for the purposes of evaluations, considering single-RAT NR BSs only. This does not mean a BS cannot benefit from the identified techniques when serving multi-RAT. Transition among power states, transition time, are implementation specific, and different BS types may support a different number of power states with different characteristics, i.e., power consumption values and required transition time.

During the transition time period, relative power of sleep mode i is assumed to be consumed. For RANI evaluation purpose, the values of relative power P for BS Category 1 and BS Category 2 for respective set of reference configurations are provided in Table 5.1-3.

Additional transition energy E and total transition time T also include energy and time for both ramping down and ramping up. The values of total transition time for BS power state transition are given in Table 5.1-4, which are the same across different sets of reference configurations for a given BS Category. The values of additional transition energy for reference configuration Set 1, Set 2 and Set 3, with unit in (relative power)*(duration in msec), are provided in Table 5.1-5.

TABLE 5.1-2
Power states of BS power consumption model

| | | | Addi- | |
|---|---|---|---|---|
| | | | tional | |
| | | Rel- | transi- | Total |
| | | ative | tion | transi- |
| Power | | Power | energy² | tion |
| state | Characteristic | P | E | time T |
| Deep | There is neither DL transmission | P1 | E1 | T1 |
| sleep¹ | nor UL reception. | | | |
| | Time interval for the sleep should | | | |
| | be larger than the total transition | | | |
| | time entering and leaving this state. | | | |
| Light | There is neither DL transmission | P2 | E2 | T2 |
| sleep | nor UL reception. | | | |
| | Time interval for the sleep should | | | |
| | be larger than the total transition | | | |
| | time entering and leaving this state. | | | |
| Micro | There is neither DL transmission | P3 | 0 | 0 |
| sleep | nor UL reception. | | | |
| | Immediate transition is assumed | | | |
| | for network energy saving study | | | |
| | purpose from or to a non-sleep | | | |
| | state. | | | |
| Active | There is only DL transmission. | P4 | N.A. | |
| DL | | | | |
| Active | There is only UL reception. | P5 | | |
| UL | | | | |

Note
¹Depending on implementations, there could be a state that the power is lower than deep sleep and requires larger total transition time, e.g. hibernating sleep or Quasi-off, which is not explicitly modelled in this study for evaluation purpose.
Note
²Unit in relative power times duration.

Below is an excerpt from the 3GPP Technical Specification (TS) 38.331 v17.2.0, where a change is shown in underlined text which highlights one example implementation according to some embodiments of the present disclosure, where the WD 22 indicates to the network node (gNB) whether a cell 18 that the WD 22 has measured is in NW energy saving mode.
MeasResults
   The IE MeasResults covers measured results for intra-frequency, inter-frequency, inter-RAT mobility and measured results for NR sidelink communication/discovery.

### MeasResults Information Element

ASNISTART

-- TAG-MEASRESULTS-START

| | |
|---|---|
| MeasResults ::= | SEQUENCE { |
| measId | MeasId, |
| measResultServingMOList | MeasResultServMOList, |
| measResultNeighCells | CHOICE { |
| measResultListNR | MeasResultListNR, |

...,

| | |
|---|---|
| measResultListEUTRA | MeasResultListEUTRA, |
| measResultListUTRA-FDD-r16 | MeasResultListUTRA-FDD-r16, |
| sl-MeasResultsCandRelay-r17 | OCTET STRING -- Contains PC5 |

```
SL-MeasResultListRelay-r17
  }
OPTIONAL,
  ...,
  [[
```

| | |
|---|---|
| measResultServFreqListEUTRA-SCG | MeasResultServFreqListEUTRA- |
| SCG | OPTIONAL, |
| measResultServFreqListNR-SCG | MeasResultServFreqListNR-SCG |

OPTIONAL,

| | |
|---|---|
| measResultSFTD-EUTRA | MeasResultSFTD-EUTRA |

OPTIONAL,

| | |
|---|---|
| measResultSFTD-NR | MeasResultCellSFTD-NR |

```
OPTIONAL
  ]],
  [[
```

| | |
|---|---|
| measResultCellListSFTD-NR | MeasResultCellListSFTD-NR |

```
OPTIONAL
  ]],
  [[
```

| | |
|---|---|
| measResultForRSSI-r16 | MeasResultForRSSI-r16 |

OPTIONAL,

| | |
|---|---|
| locationInfo-r16 | LocationInfo-r16 |

OPTIONAL,

| | |
|---|---|
| ul-PDCP-DelayValueResultList-r16 | UL-PDCP-DelayValueResultList-r16 |

OPTIONAL,

| | |
|---|---|
| measResultsSL-r16 | MeasResultsSL-r16 |

OPTIONAL,

| | |
|---|---|
| measResultCLI-r16 | MeasResultCLI-r16 |

```
OPTIONAL
  ]],
  [[
```

| | |
|---|---|
| measResultRxTxTimeDiff-r17 | MeasResultRxTxTimeDiff-r17 |

OPTIONAL,

| | |
|---|---|
| sl-MeasResultServingRelay-r17 | OCTET STRING |

OPTIONAL,

-- Contains PC5 SL-

MeasResultRelay-r17

| | |
|---|---|
| ul-PDCP-ExcessDelayResultList-r17 | UL-PDCP-ExcessDelayResultList-r17 |

OPTIONAL,

| | |
|---|---|
| coarseLocationInfo-r17 | OCTET STRING |

OPTIONAL
]]
}

| | |
|---|---|
| MeasResultServMOList ::= | SEQUENCE (SIZE (1..maxNrofServingCells)) |

OF MeasResultServMO

| | |
|---|---|
| MeasResultServMO ::= | SEQUENCE { |
| servCellId | ServCellIndex, |
| measResultServingCell | MeasResultNR, |
| measResultBestNeighCell | MeasResultNR |

OPTIONAL,
...
}

| | |
|---|---|
| MeasResultListNR ::= | SEQUENCE (SIZE (1..maxCellReport)) OF |

MeasResultNR

| | |
|---|---|
| MeasResultNR ::= | SEQUENCE { |
| physCellId | PhysCellId |

OPTIONAL,

| | |
|---|---|
| measResult | SEQUENCE { |
| cellResults | SEQUENCE{ |
| resultsSSB-Cell | MeasQuantityResults |

OPTIONAL,

| | |
|---|---|
| resultsCSI-RS-Cell | MeasQuantityResults |

OPTIONAL
},

| | |
|---|---|
| rsIndexResults | SEQUENCE{ |
| resultsSSB-Indexes | ResultsPerSSB-IndexList |

OPTIONAL,

| | |
|---|---|
| resultsCSI-RS-Indexes | ResultsPerCSI-RS-IndexList |

```
OPTIONAL
    }
OPTIONAL
  },
  ...,
  [[
```

| | |
|---|---|
| cgi-Info | CGI-InfoNR |

```
OPTIONAL
  ]],
  [[
```

| | |
|---|---|
| choCandidate-r17 | ENUMERATED {true} |

OPTIONAL,

| | |
|---|---|
| choConfig-r17 | SEQUENCE (SIZE (1..2)) OF |
| CondTriggerConfig-r16 | OPTIONAL, |
| triggeredEvent-r17 | SEQUENCE { |
| timeBetweenEvents-r17 | TimeBetweenEvent-r17 |

OPTIONAL,

| | |
|---|---|
| firstTriggeredEvent | ENUMERATED {condFirstEvent, |
| condSecondEvent} | OPTIONAL |

```
  }
OPTIONAL
  ]],
  [[
  nw-EE-mode ENUMERATED {true} OPTIONAL
  ]]
}
```

| | |
|---|---|
| MeasResultListEUTRA ::= | SEQUENCE (SIZE (1..maxCellReport)) OF |

MeasResultEUTRA

| | |
|---|---|
| MeasResultEUTRA ::= | SEQUENCE { |
| eutra-PhysCellId | PhysCellId, |
| measResult | MeasQuantityResultsEUTRA, |
| cgi-Info | CGI-InfoEUTRA |

OPTIONAL,
...
}

| | |
|---|---|
| MultiBandInfoListEUTRA ::= | SEQUENCE (SIZE (1..maxMultiBands)) OF |

FreqBandIndicatorEUTRA

| | |
|---|---|
| MeasQuantityResults ::= | SEQUENCE { |
| rsrp | RSRP-Range |

OPTIONAL,

| | |
|---|---|
| rsrq | RSRQ-Range |

OPTIONAL,

| | |
|---|---|
| sinr | SINR-Range |

OPTIONAL
}

| | |
|---|---|
| MeasQuantityResultsEUTRA ::= | SEQUENCE { |
| rsrp | RSRP-RangeEUTRA |

OPTIONAL,

| | |
|---|---|
| rsrq | RSRQ-RangeEUTRA |

OPTIONAL,

| | |
|---|---|
| sinr | SINR-RangeEUTRA |

OPTIONAL
}

| | |
|---|---|
| ResultsPerSSB-IndexList::= | SEQUENCE (SIZE |

(1..maxNrofIndexesToReport2)) OF ResultsPerSSB-Index

| | |
|---|---|
| ResultsPerSSB-Index ::= | SEQUENCE { |
| ssb-Index | SSB-Index, |
| ssb-Results | MeasQuantityResults |

OPTIONAL
}

| | |
|---|---|
| ResultsPerCSI-RS-IndexList::= | SEQUENCE (SIZE |

(1..maxNrofIndexesToReport2)) OF ResultsPerCSI-RS-Index

| | |
|---|---|
| ResultsPerCSI-RS-Index ::= | SEQUENCE { |
| csi-RS-Index | CSI-RS-Index, |
| csi-RS-Results | MeasQuantityResults |

OPTIONAL
}
MeasResultServFreqListEUTRA-SCG ::= SEQUENCE (SIZE
(1..maxNrofServingCellsEUTRA)) OF MeasResult2EUTRA
MeasResultServFreqListNR-SCG ::= SEQUENCE (SIZE (1..maxNrofServingCells))
OF MeasResult2NR

| | |
|---|---|
| MeasResultListUTRA-FDD-r16 ::= | SEQUENCE (SIZE (1..maxCellReport)) |

OF MeasResultUTRA-FDD-r16

| | |
|---|---|
| MeasResultUTRA-FDD-r16 ::= | SEQUENCE { |
| physCellId-r16 | PhysCellIdUTRA-FDD-r16, |
| measResult-r16 | SEQUENCE { |
| utra-FDD-RSCP-r16 | INTEGER (−5..91) OPTIONAL, |
| utra-FDD-EcN0-r16 | INTEGER (0..49) OPTIONAL |

}
}

| | |
|---|---|
| MeasResultsForRSSI-r16 ::= | SEQUENCE { |
| rssi-Result-r16 | RSSI-Range-r16, |
| channelOccupancy-r16 | INTEGER (0..100) |

}

| | |
|---|---|
| MeasResultCLI-r16 ::= | SEQUENCE { |
| measResultListSRS-RSRP-r16 | MeasResultListSRS-RSRP-r16 |

OPTIONAL,

| | |
|---|---|
| measResultListCLI-RSSI-r16 | MeasResultListCLI-RSSI-r16 |

OPTIONAL
}

| | |
|---|---|
| MeasResultListSRS-RSRP-r16 ::= | SEQUENCE (SIZE (1.. maxCLI-Report-r16)) |

OF MeasResultSRS-RSRP-r16

| | |
|---|---|
| MeasResultSRS-RSRP-r16 ::= | SEQUENCE { |
| srs-ResourceId-r16 | SRS-ResourceId, |
| srs-RSRP-Result-r16 | SRS-RSRP-Range-r16 |

}
MeasResultListCLI-RSSI-r16 ::= SEQUENCE (SIZE (1.. maxCLI-Report-r16)) OF
MeasResultCLI-RSSI-r16

| | |
|---|---|
| MeasResultCLI-RSSI-r16 ::= | SEQUENCE { |
| rssi-ResourceId-r16 | RSSI-ResourceId-r16, |
| cli-RSSI-Result-r16 | CLI-RSSI-Range-r16 |

}
UL-PDCP-DelayValueResultList-r16 ::= SEQUENCE (SIZE (1..maxDRB)) OF UL-
PDCP-DelayValueResult-r16
UL-PDCP-DelayValueResult-r16 ::= SEQUENCE {

| | |
|---|---|
| drb-Id-r16 | DRB-Identity, |
| averageDelay-r16 | INTEGER (0..10000), |

...
}
UL-PDCP-ExcessDelayResultList-r17 ::= SEQUENCE (SIZE (1..maxDRB)) OF
UL-PDCP-ExcessDelayResult-r17
UL-PDCP-ExcessDelayResult-r17 ::= SEQUENCE {

| | |
|---|---|
| drb-Id-r17 | DRB-Identity, |
| excessDelay-r17 | INTEGER (0..31), |

...
}
TimeBetweenEvent-r17 ::= INTEGER (0..1023)
-- TAG-MEASRESULTS-STOP
-- ASN1STOP

### EXAMPLES

Example A1. A first network node 16 in a first cell configured to communicate with a wireless device 22 (WD 22) and a second network node 16 in a second cell, the first network node 16 configured to, and/or comprising a radio interface 62 and/or comprising processing circuitry 68 configured to:
serve the WD 22 in the first cell;
receive a first indication that the second network node 16 is operating in a first network energy savings (NES) mode, the first indication being received from one of the WD 22 and the second network node 16;
determine, based on at least the first indication, a handover configuration for the WD 22;
cause transmission of a second indication to the second network node 16 based on the handover configuration, the second indication configured to cause the second network node 16 to transition from the first NES mode to a second mode, the second mode being one of a second NES mode or a non-NES mode of operation; and
cause a handover of the WD 22 to the second network node 16 in accordance with the handover configuration.

Example A2. The first network node 16 of Example A1, wherein the second indication corresponds to a handover request.

Example A3. The first network node 16 of any of Examples A1 and A2, wherein the first network node 16 is further configured to:
predict, based on location information associated with the WD 22, an upcoming handover opportunity; and
cause transmission of the second indication to the second network node 16 based on the predicted upcoming handover opportunity.

Example B1. A method implemented in a first network node 16 in a first cell configured to communicate with a wireless device 22 (WD 22) and a second network node 16 in a second cell, the method comprising:
serving the WD 22 in the first cell;
receiving a first indication that the second network node 16 is operating in a first network energy savings (NES) mode, the first indication being received from one of the WD 22 and the second network node 16;
determining, based on at least the first indication, a handover configuration for the WD 22;
transmitting a second indication to the second network node 16 based on the handover configuration, the second indication configured to cause the second network node 16 to transition from the first NES mode to a second mode, the second mode being one of a second NES mode or a non-NES mode of operation; and
causing a handover of the WD 22 to the second network node 16 in accordance with the handover configuration.

Example B2. The method of Example B1, wherein the second indication corresponds to a handover request.

Example B3. The method of any of Examples B1 and B2, wherein the method further comprises:
predicting, based on location information associated with the WD 22, an upcoming handover opportunity; and
transmitting the second indication to the second network node 16 based on the predicted upcoming handover opportunity.

Example C1. A first network node 16 in a first cell configured to communicate with a wireless device 22 (WD 22) and a second network node 16 in a second cell, the first network node 16 configured to, and/or comprising a radio interface 62 and/or comprising processing circuitry 68 configured to:
receive, store, and/or determine a network energy savings (NES) configuration;
while the first network node 16 is operating in a first NES mode according to the NES configuration, receive a first indication from the second network node 16 requesting a handover of the WD 22 from the second network node 16 to the first network node 16; and
determine, based on at least the first indication and the NES configuration, whether to perform a wake up procedure and/or a handover procedure of the WD 22.

Example C2. The first network node 16 of Example C1, wherein the determining of whether to perform the wake up procedure and/or the handover procedure is further based on at least one of:
a traffic load of the first network node 16;
a quality of service requirement of the WD 22;
a service type requested by and/or associated with the WD 22;
an emergency state of the WD 22;
a location of the WD 22; and/or
a velocity of the WD 22.

Example C3. The first network node 16 of any of Examples C1 and C2, wherein the wake up procedure includes, based on the first indication and/or the NES configuration:
transitioning from the first NES mode to a second NES mode, the first NES mode not enabling service of the WD 22 in the first cell, the second NES enabling service of the WD 22 in the first cell; or
transitioning from the first NES mode to a normal (i.e., non-NES) mode, the normal mode enabling service of the WD 22 in the first cell.

Example D1. A method implemented in a first network node 16 in a first cell configured to communicate with a wireless device 22 (WD 22) and a second network node 16 in a second cell, the first network node 16 configured to, and/or comprising a radio interface 62 and/or comprising processing circuitry 68 configured to:
receiving, storing, and/or determining a network energy savings (NES) configuration;
while the first network node 16 is operating in a first NES mode according to the NES configuration, receiving a first indication from the second network node 16 requesting a handover of the WD 22 from the second network node 16 to the first network node 16; and
determining, based on at least the first indication and the NES configuration, whether to perform a wake up procedure and/or a handover procedure of the WD 22.

Example D2. The method of Example D1, wherein the determining of whether to perform the wake up procedure and/or the handover procedure is further based on at least one of:
a traffic load of the first network node 16;
a quality of service requirement of the WD 22;
a service type requested by and/or associated with the WD 22;
an emergency state of the WD 22;
a location of the WD 22; and/or
a velocity of the WD 22.

Example D3. The method of any of Examples D1 or D2, wherein the wake up procedure includes, based on the first indication and/or the NES configuration:
transitioning from the first NES mode to a second NES mode, the first NES mode not enabling service of the WD 22 in the first cell, the second NES enabling service of the WD 22 in the first cell; or
transitioning from the first NES mode to a normal (i.e., non-NES) mode, the normal mode enabling service of the WD 22 in the first cell.

Example E1. A wireless device 22 (WD 22) configured to communicate with a first network node 16 in a first cell and a second network node 16 in a second cell, the WD 22 configured to, and/or comprising a radio interface 82 and/or processing circuitry 84 configured to:
measure signaling from the second network node 16;
determine or estimate a network energy savings (NES) mode of the second network node 16 based on the measured signaling;
cause transmission of a first indication to the first network node 16 of the determined/estimated NES mode of the second network node 16; and
receive, responsive to the first indication, a second indication from the first network node 16 causing the WD 22 to perform a handover procedure.

Example E2. The WD 22 of Example E1, wherein the WD 22 is further configured to:
measure signaling from a third network node 16 in a third cell;
determine the third network node 16 to be operating in a normal (i.e., non-NES) mode;
the first indication to the first network node 16 indicating that the third network node 16 is in the normal mode; and
the handover from the first network node 16 being to one of:
   the second network node 16 based on a first quality of the measured signaling from the second network node 16 being greater than a second quality of the measured signaling from the third network node 16; or
   the third network node based on the second network node 16 being in the NES mode.

Example E3. The WD 22 of any one of Examples E1 and E2, wherein the first indication indicates that the WD 22 is in an emergency state, the second indication causing the WD 22 to perform a handover to the second network node 16 based on the WD 22 being in the emergency state.

Example F1. A method implemented in a wireless device 22 (WD 22) configured to communicate with a first network node 16 in a first cell and a second network node 16 in a second cell, the method comprising:
measuring signaling from the second network node 16;
determining or estimating a network energy savings (NES) mode of the second network node 16 based on the measured signaling;
transmitting a first indication to the first network node 16 of the determined/estimated NES mode of the second network node 16; and
receiving, responsive to the first indication, a second indication from the first network node 16 causing the WD 22 to perform a handover procedure.

Example F2. The method of Example F1, wherein the method further comprises:
measuring signaling from a third network node 16 in a third cell;
determining the third network node 16 to be operating in a normal (i.e., non-NES) mode;
the first indication to the first network node 16 indicating that the third network node 16 is in the normal mode; and
the handover from the first network node 16 being to one of:
   the second network node 16 based on a first quality of the measured signaling from the second network node 16 being greater than a second quality of the measured signaling from the third network node 16; or
   the third network node 16 based on the second network node 16 being in the NES mode.

Example F3. The method of any one of Examples F1 and F2, wherein the first indication indicates that the WD 22 is in an emergency state, the second indication causing the WD 22 to perform a handover to the second network node 16 based on the WD 22 being in the emergency state.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in
the preceding description include:

| | |
|---|---|
| BS | Base station |
| C-DRX | Connected mode Discontinuous Reception |
| CHO | Conditional Handover |
| CRS | Channel Reference Signal |
| CU | Centralized Unit |
| DCI | Downlink Control Information |
| DL | Downlink |
| DRX | Discontinuous Reception |
| DTX | Discontinuous Transmission |
| DU | Distributed Unit |
| eNB | Base station in LTE |
| gNB | Base station in NR |
| HARQ | Hybrid Automatic Request |
| LTE | Long Term Evolution |
| MAC | Medium Access Control |
| MCG | Master Cell Group |
| MN | Master Node |
| NDI | New Data Indicator |
| NES | NW Energy Saving |
| NG | New Generation |
| NR | New Radio |
| NW | Network |
| PDCCH | Physical Downlink Control Channel |
| PDCP | Packet Data Convergence Protocol |
| PDSCH | Physical Downlink Shared Channel |
| PSBCH | Physical Sidelink Broadcast Channel |
| PSCCH | Physical Sidelink Control Channel |
| PSFCH | Physical Sidelink Feedback Channel |
| PSSCH | Physical Sidelink Shared Channel |
| RAN | Radio Access Network |
| RAT | Radio Access Technology |
| RLC | Radio Link Control |
| RRC | Radio Resource Control |
| RS | Reference Signal |
| SCG | Secondary Cell Group |
| SIB | System Information Block |
| SN | Secondary Node |
| SRB | Signalling Radio Bearer |
| SSB | Synchronization Signalling Block |
| TDD | Time Division Duplexing |
| UCI | Uplink Control Information |
| UE | User Equipment (Wireless device in 3GPP systems) |
| UL | Uplink |
| WUS | Wake-up Signal |
| 3GPP | 3rd Generation Partnership Project |
| 5QI | 5G Quality of service Identifier |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1.-10. (canceled)

11. A method implemented by a first network node that is configured to communicate with a wireless device and a second network node, the method comprising:
receiving a first indication indicating the second network node is operating in a first operating mode, the first operating mode being a non-network energy savings, NES, mode or one of a plurality of NES modes;
determining whether the second network node should transition to a second operating mode different from the first operating mode, the second operating mode being the non-NES mode or one of the plurality of NES modes; and
transmitting a request for the second network node to transition to the second operating mode, the request being based on the determination to transition the second network node.

12. The method of claim 11, wherein the second operation mode is a NES-mode, and the request is configured to request for the second network node to transition from the NES-mode to a non-NES mode.

13. The method of claim 11, wherein the first indication is received by the wireless device.

14. The method of claim 13, further comprising determining to handover the wireless device to the second network node, the determination to transition the second network node to the second operating mode is based on the handover determination.

15. The method of claim 13, wherein the first indication is received in a measurement report.

16. The method of claim 11, wherein the first indication is received from the second network node, the second network node is a target node for handover.

17. The method of claim 16, further comprising receiving, from the second network node, information indicating that the second network node is configured to enter the non-NES mode to support at least one predefined service.

18. The method of claim 17, wherein the at least one predefined service comprises one of an emergency service or a service having a predefined 5G quality of service Identifier, 5QI, value.

19. The method of claim 11, wherein the first network node is a master node and the second network node is a secondary node; and
the transition of the second network node to the second operating mode being configured to provide a secondary cell group, SCG, configuration for the wireless device.

20. The method of claim 11, wherein the determination that the second network node should transition to the second operating mode is based on at least one of a speed of the wireless device or a position of the wireless device.

21. The method of claim 11, further comprising:
receiving a plurality of indications from a plurality of network nodes, each indication indicating whether a respective network node of the plurality of network nodes is operating in the first operating mode; and
determining to handover a wireless device to one of the plurality of network nodes that is operating in the non-NES mode.

22. A first network node configured to communicate with a wireless device and a second network node, the first network node configured to:
receive a first indication indicating the second network node is operating in a first operating mode, the first operating mode being a non-network energy savings, NES, mode or one of a plurality of NES modes;
determine whether the second network node should transition to a second operating mode different from the first operating mode, the second operating mode being the non-NES mode or one of the plurality of NES modes; and
transmit a request for the second network node to transition to the second operating mode, the request being based on the determination to transition the second network node.

23. The first network node of claim 22, wherein the second operation mode is a NES-mode, and the request is configured to request for the second network node to transition from the NES-mode to a non-NES mode.

24. The first network node of claim 22, wherein the first indication is received by the wireless device.

25. The first network node of claim 24, wherein the first network node is configured to determine to handover the wireless device to the second network node, the determination to transition the second network node to the second operating mode is based on the handover determination.

26. The first network node of claim 24, wherein the first indication is received in a measurement report.

27. The first network node of claim 22, wherein the first indication is received from the second network node, the second network node is a target node for handover.

28. The first network node of claim 27, wherein the first network node is further configured to receive, from the second network node, information indicating that the second network node is configured to enter the non-NES mode to support at least one predefined service.

29. The first network node of claim 28, wherein the at least one predefined service comprises one of an emergency service or a service having a predefined 5G quality of service Identifier, 5QI, value.

30. The first network node of claim 22, wherein the first network node is a master node and the second network node is a secondary node; and
the transition of the second network node to the second operating mode being configured to provide a secondary cell group, SCG, configuration for the wireless device.

31.-46. (canceled)
